(19) United States
(12) Patent Application Publication
(10) Pub. No.: US 2014/0038149 A1
(43) Pub. Date: Feb. 6, 2014

(54) Chinese Meridian Health Apparel with Strips and Circles

(71) Applicant: Ramiro C. De La Cruz, Flower Mound, TX (US)

(72) Inventor: Ramiro C. De La Cruz, Flower Mound, TX (US)

(21) Appl. No.: 13/567,041

(22) Filed: Aug. 4, 2012

(51) Int. Cl. G09B 23/00

(52) U.S. Cl. 434/262

(57) ABSTRACT

A therapeutic outfit or body suit design that has the Chinese meridian pathways sewed in or imprinted on each piece of apparel. The Chinese meridian pathways are strips and circles that are placed at the chi energy pathways of the body. The outfit or body suit can be apparel that is snug to the body or loose on the body. The strips and circles on the therapeutic outfit or body suit are heated by the Sun (Solar) or power source. The heated strips and circles promote circulation of blood and chi through the body maintaining physical and emotional well-being.

### BACKGROUND OF INVENTION

1. Field of the Invention

The present invention relates to applying heat to the apparel strips and circles. These apparel strips and circles run along the Chinese meridian pathways and acupuncture points throughout the entire body from head to toe. The apparel strips and circles are composed of a heat generating fabric, yarn or a fabric layer within the apparel for use against the skin surface of the human body to generate heat in the Chinese meridian pathways and acupuncture points.

2. Discussion of the Related Art

There are 14 primary meridian pathways with acupuncture points which may be grouped in pairs and are associated to organs of the body. They are:
Yang Arm Meridian: Small Intestine, Triple Heater, Large Intestine
Yin Arm Meridian: Lung, Pericardium, Heart
Yang Leg Meridian: Urinary Bladder, Gall Bladder, Stomach
Yin Leg Meridian: Spleen, Liver, Kidney
Extraordinary: Governing Vessel, Conception vessel

Other acupuncture points:
Ni quan: Center of palm
Yong quan: Front center of bottom of foot
Chi: is the life force energy that flows through the meridians in the human body.

Chinese meridian diagram:

### BRIEF SUMMARY OF THE INVENTION

The apparel has strips and circles which are placed and correspond to where the Chinese meridian pathways and acupuncture points are located on the human body. The apparel may be an outfit or body suit which is comprised of a head covering, upper body tops, lower body trousers and shorts, under garments, and foot coverings. The outfit or body suit can be one piece or several pieces and may be combined with other apparel. The outfit or body suit can be one color or many color combinations with the primary color black for all the strips and circles sewed, stitched, or printed along the Chinese meridian pathways and acupuncture points. The apparel strips and circles can be heated using the Sun or a small DC battery that generates heat in the conductive yarn when electric current passes through it.

### BRIEF DESCRIPTION OF THE DRAWINGS

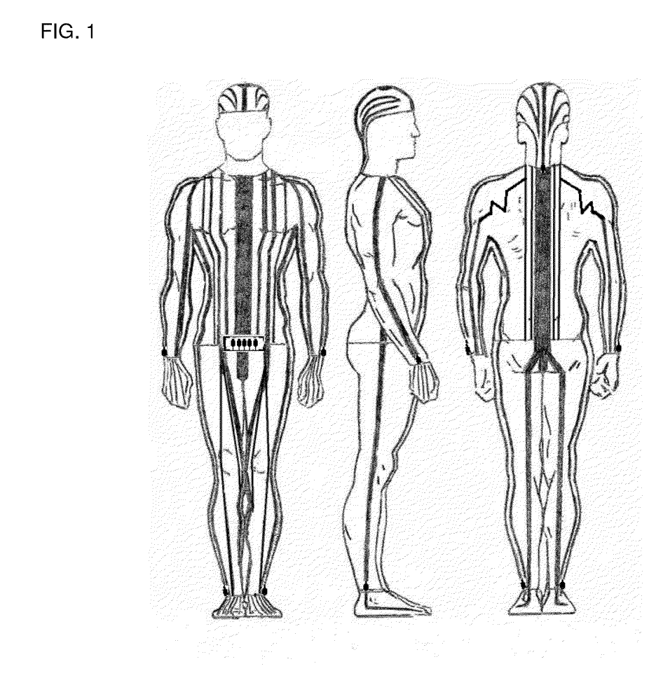

1. FIG. 1 is an enlarged view of the front, right side, and back of the complete outfit. The left side view is a mirror image of the right side. These views include all the heated strips and connections of the head covering, top (garments that cover the torso), trousers and shorts, hand covering, and foot covering

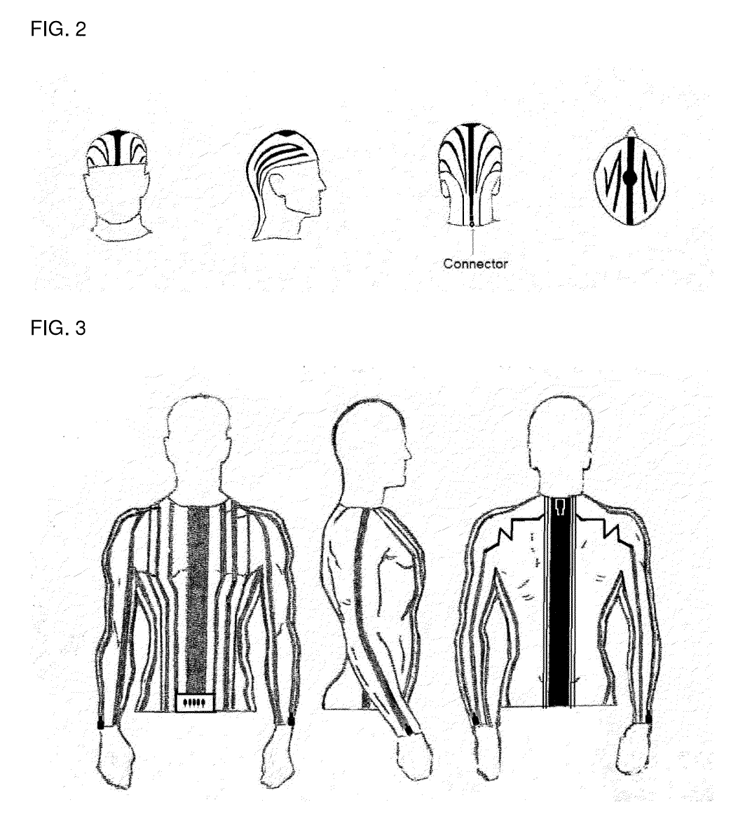

2. FIG. 2 is the Head Covering front, right side, back of the head and top of the head.

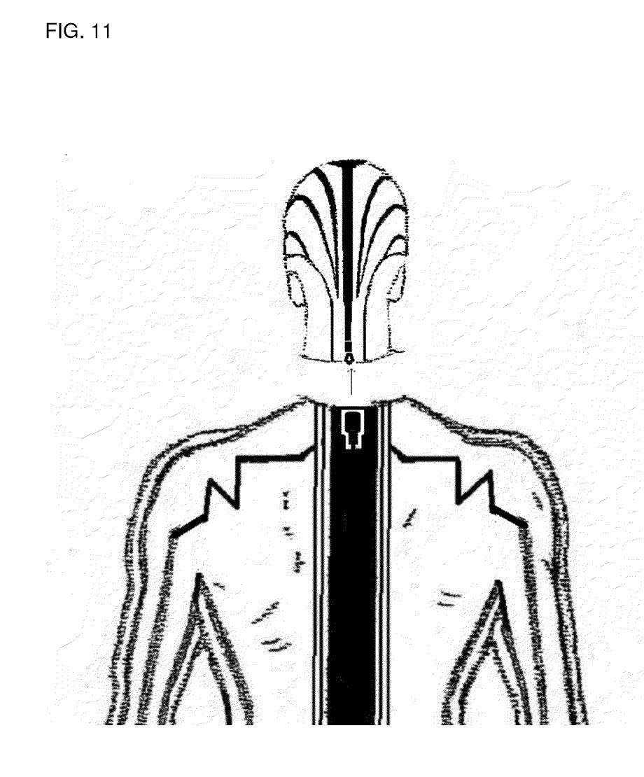

The left side view is a mirror image of the right side view. A strip runs through the middle of the head covering from front to back with a circle on top of the head. Another strip that looks like an elongated alphabetic letter Z is on both sides of the head. The head covering is configured to fit snugly on the scalp. The strips and circles can be heated using Sun (solar) power or DC power. The head covering can be connected to the top (garments that cover the torso) where the head center line meets the top (Garments that cover the torso) centerline using standard 12 volt DC connectors. See FIGS. 2 and 11

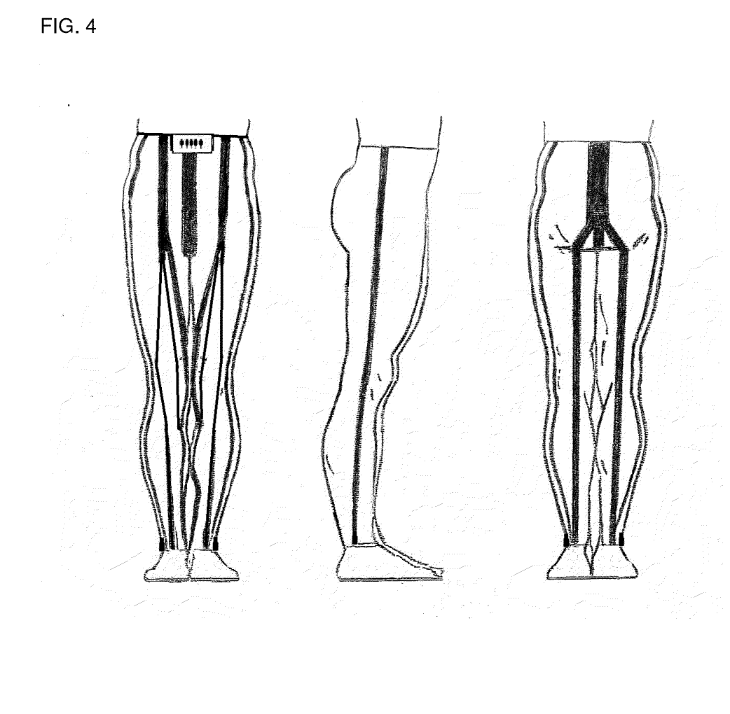

3. FIG. 3 is the Top (Garments that cover the torso): There are twenty strips on the torso top. Four strips for each arm (front, back, outside and inside); the torso has twelve strips (middle front and back, three on each side of the middle front strip, two strips on each side of the back middle strip and two strips on the outside of the torso. The top (garments that cover the body) can be connected to the head covering where the top meets the head covering center line. The top connects to the trousers and shorts where the center line meets the trouser and shorts center line using standard wire harness connector. See FIGS. 1, 3 and 10

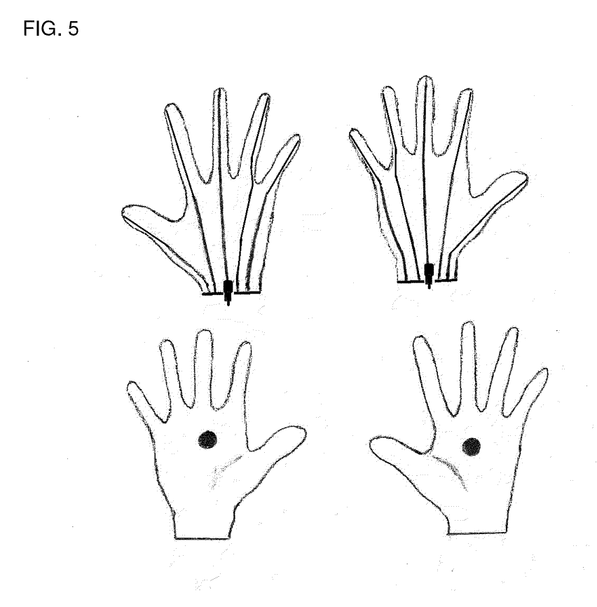

4. FIG. 4 is the Trousers and shorts: A strip runs down and up the middle front and back of the trouser and shorts. Another three strips run down the front, back, outside/inside the knee and inside the leg. Another two strips form a V shape that runs from the outside the groin area to inside the knee down the leg to the area above the ankle bone. The trousers and shorts can be connected to the top garments that cover the torso) where the center lines meet using electronic wire harness connector. The connection to the foot covering is where the outside leg strip meets the ankle bone using standard 12 volt DC connectors. See FIGS. 1, 4, 10 and 13

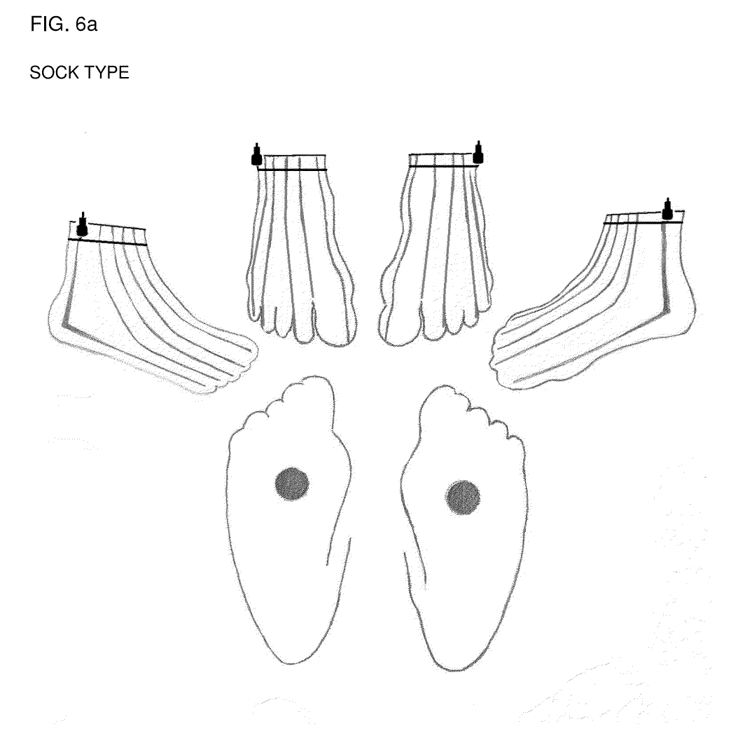

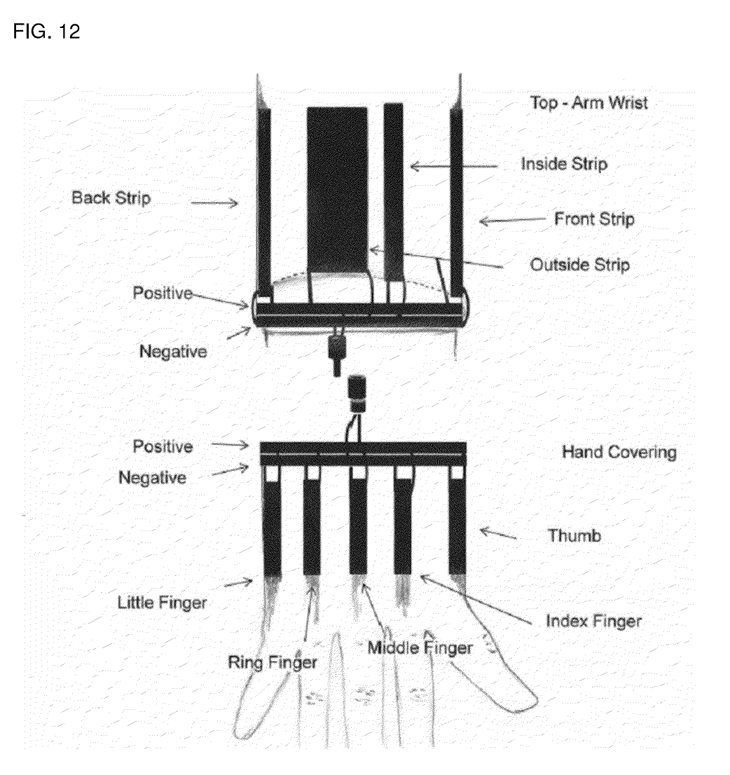

5. FIG. 5 is the Hand Coverings: Five strips run down the wrist to each fingertip. A circle is in the center of each palm. The hand covering can be connected to the top (garments that cover the torso) where the outside arm strip meets the wrist using standard 12 volt DC connectors. The hand covering are configured to fit snugly on the left and right hands. See FIG. 12

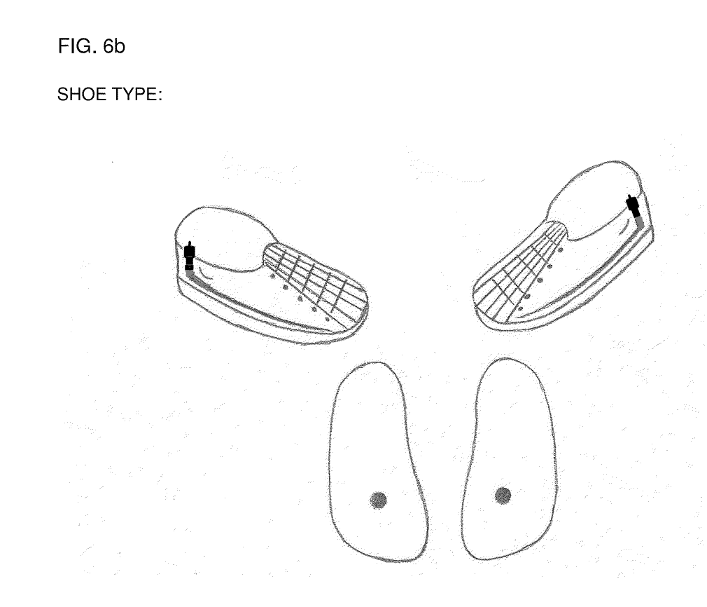

6. FIG. 6 is the Foot Coverings and Foot Wear: Five strips run down the foot to the toes. One line runs outside the foot under the ankle bone to the little toe. Another line runs down and under the inside ankle bone to the big toe. Three lines run down the front of the foot to the three middle toes. Also, a circle is on the bottom of the front of the foot covering. FIG. 6a are the views of a sock type of apparel, FIG. 6b are the views of the shoe type of apparel. The foot covering are configured to fit snugly on the left and right foot. The shoe strips and circle location are a mirror image of the sock. The foot covering can be connected to the trousers and shorts where the outside leg strip meets the outside ankle bone of the sock using standard 12 volt connectors. The sock can be connected to the shoe at the outside ankle bone using standard wire connectors. Connecting the trousers and shorts, socks and shoes is accomplished using standard 12 volt DC connectors. See FIGS. 1, 6a, 6b and 13

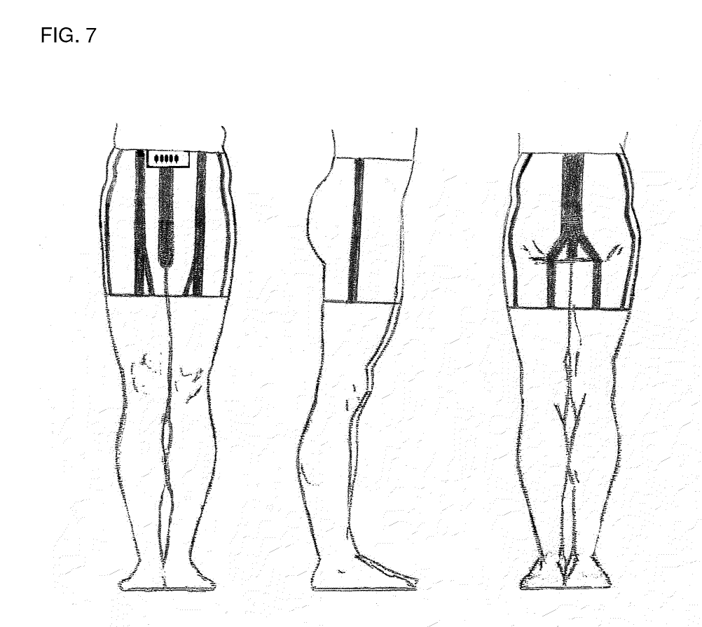

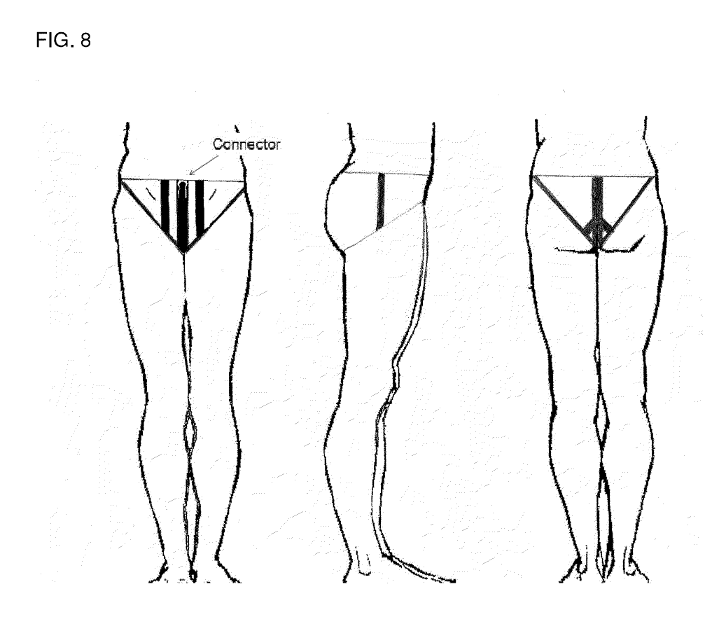

7. FIG. 7 is an enlarged view of the front, right side, and back of the Trousers and Shorts or under garment. The left side view is a mirror image of the right side. This includes the strips for each view. The strips locations are matching the trousers and shorts. The trousers and shorts or undergarment can be connected to the top (garments that cover the torso) where the center lines meet using electronic wire harness connector or a brief connector FIG. 8.

8. FIG. 8 is an enlarged view of the front, right side, and back of the brief under garment. The left side view is a mirror image of the right side. This includes the strips for each view. The strips locations are matching the trousers and shorts. The brief under garment can be connected to the top (garments that cover the torso) where the center lines meet using a standard wire connector.

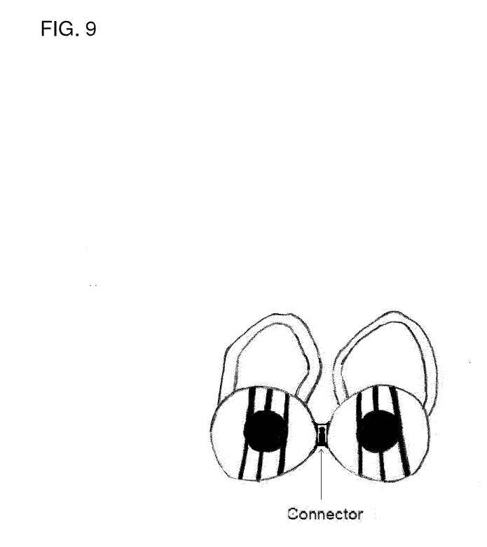

9. FIG. 9 is and enlarged view of the Bra front. The Bra has all four strips that run up and down the body torso. The strips locations are matching the top (garments that cover the torso) apparel. A circle is placed at the center of the breast. The Bra can be connected to the top (garments that cover the torso) where the center lines meet using a standard wire connector.

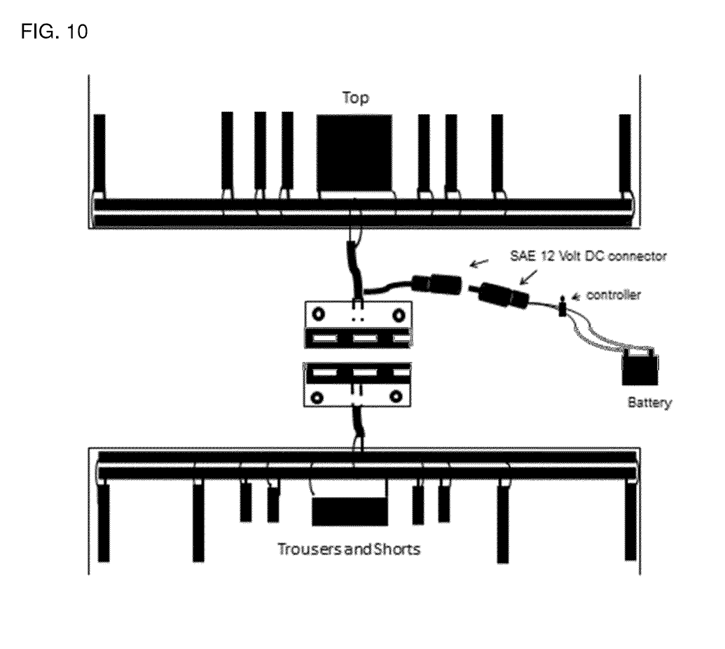

10. FIG. 10 is and enlarged view of the connection points of the Top and Trousers and Shorts. The strips correspond to the strips of the Top in FIG. 3 and the Trousers and Shorts in FIG. 4. The up and down strips are the apparel strips and the horizontal two lines represent a two conductor wire that is wrapped around the Top of the Trousers and Shorts. The Top and Trousers and Shorts are connected together with a harness connector and a 12 volt DC connector which is connected to power from a battery.

11. FIG. 11 is the Top connection to the Head Covering. The strips correspond to the Top strips in FIG. 3 and the Head covering strips in FIG. 2. They are connected together with standard wire connectors.

12. FIG. 12 is the Top sleeve and the Hand Covering. The strips correspond to the top strips that go down the arm as in FIG. 3. The two horizontal lines represent a two conductor wire that wraps around the wrist. The Hand covering strips correspond to the strips in FIG. 5 of the fingers with two horizontal lines that wrap around the wrist represent a two wire conductor. A standard 12 volt DC connector is used to connect the Top and Hand Covering.

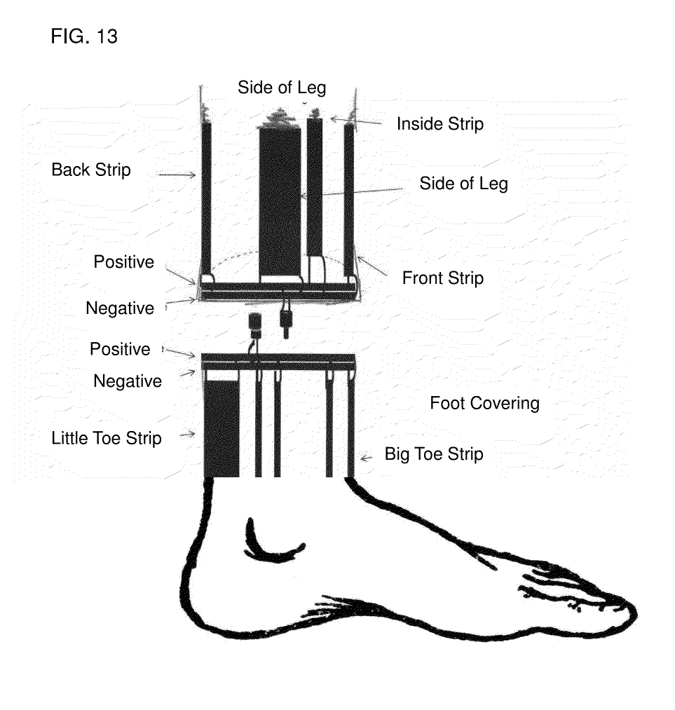

13. FIG. 13 is the Trouser leg bottom with the corresponding strips (front, back, inside, and outside) that run down the leg like in FIG. 4 with two horizontal lines that represent two conductor wires that wrap around the bottom. The bottom is a picture of the Foot Covering with the strips that correspond to FIGS. 6a and 6b. They are connected together with a standard 12 volt DC connector.

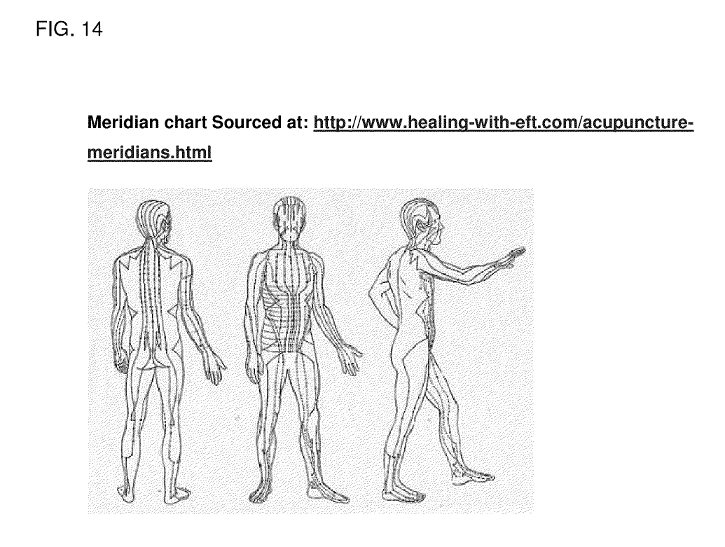

14. FIG. 14 is a picture of the meridians on the human body. It is called a Meridian chart. The picture has the back, front, and side view of the meridians on the human body.

### DETAILED DESCRIPTION OF THE INVENTION

FIG. 1 is a complete outfit or body suit which is comprised of head covering, top (garments covering the torso), trousers and shorts, hand covering, under garments, and foot wear. The outfit or body suit can be one piece or several pieces and may be combined with other apparel. The head covering may be a cap, hat, sweatband, beanie, hood or any garment that covers the head. The upper body top (garments that cover the torso) may be a one piece suit, long sleeve shirt, t-shirt, jersey, jacket, sleeves, sweat shirt, bra, or any apparel that covers the torso. The trousers and shorts may be sports pants, jeans, sweat pants, shorts, hosiery, or any other type of apparel that covers the lower body. The under garment may be underwear, bra, shorts, or any other under garment worn under other apparel. The hand coverings may be gloves, mittens or any other type of hand covering. The foot wear may be socks, stockings, ankle warmers, shoes or any foot covering. The strips are as thin as 0.8 mm. Wider strips are sized proportional to a person's size. The circles are one inch circumference. There are two ways of heating the strips and circles, one is using a battery (DC power) and the other is using the Sun (solar). All, one, or combination of a strip or circles corresponding with the Chinese meridian pathways and acupuncture points can be heated using the outfit with DC power. The DC powered fabric is a conductive polymeric yarn or a fabric layer that can be heated using energy efficient batteries like the ones used in cell phones (3.7 volts), power packs that include several small batteries packaged together, or larger batteries in motorcycle's, car's, boat's, etc. Heated clothing controllers from motorcycle companies can be used to control the amount of heat desired in one, all or combination of strips or circle's. The heating material produces heat when electric current passes through it, converting the power supplied directly to heat. By regulating the voltage applied, the heating element can be made to heat up to a pre-defined level to create a uniform area of heat. The heat applied to the polymer generates Far Infrared(FIR) energy, the FIR rays penetrate the skin to a depth of four centimeters. When the far infrared energy strikes the skin it causes the surface electrons to excite and oscillate which creates heat. The increased heat leads to expansion of blood vessels and capillaries, improving blood circulation which improves blood flow and Chi flow. The complete outfit or body suit is connected at six locations. The head garment is connected to the top where they meet and the hand coverings are connected where they meet the top of the wrist. The trousers and shorts are connected to the top at the belt line where the belt buckle would be located. The trousers are connected to the foot coverings and foot wear where the ankle bone meets the trousers. The apparel can be connected to each other using standard 12 volt DC power connectors, this allows for the various apparel pieces to share the DC power. Using the Sun (solar) to heat the fabric will supply heat to the black strips and circles on the Chinese meridian pathways and acupuncture points. The strips and circles fabric will be a dark color to capture the Sun's rays heating effect. Other dark colors that absorb the sun's rays can be used but black is the preferred color for the strips and circles. The Sun (solar) apparel can accomplish heating one strip or circle by only including that strip or circle on the apparel. The Sun (solar) outfit still provides the same benefits as the DC powered outfits but is limited to what strips and circles the Sun is shining on. This apparel does not need to be connected together with power connectors since the power comes from the Sun (solar). The outfits are composed of tight and loose clothing. Tight fitting fabric can be made of stretch cotton, spandex or other man-made material that is elastic to fit snug or cling to the body, head or appendage which keeps the designations of the meridian pathways remaining at the same relative position along the body while the apparel item is being worn. Lightweight materials such as cotton, wool or man-made fabrics may be used for loose fitting apparel. Loose apparel with meridian pathways and acupuncture points that barely touch the skin still provides benefit. The complete outfit or body suit can be colored; the primary colors are green, blue, red, orange, yellow, white, brown, black, gold, grey, pink, purple, and silver. These colors are associated with body organ therapy. Fluorescent colors that glow in the dark or under lighting can also be used. Any color can be used and can be matched with different colors not on the list above to enhance the aesthetic appeal.

What is claimed is:

1. A product that provides an apparel outfit or body suit with strips and circles located at the Chinese meridian pathways and acupuncture points.

2. A product of claim 1, wherein the apparel outfit or body suit is selected from a group consisting of a head covering, top(garments that cover the torso), trousers and shorts, under garments, bra, hand covering, and foot coverings.

3. A product of claim 1, wherein one, all or combinations of the strips are replaced with circles located at acupuncture points.

4. A product of claim 1, the strips and circles can be solid, dashed, dotted, circled, patterned or any other character that can be used to create a strip line or circle.

5. A product of claim 4, wherein any or all strips and circles can be replaced with triangles, stars, diamonds, octagons, hexagons, asterisks, or any other ancient or modern symbols.

6. A product of claim 1, wherein the strips and circles are heated using a power source

7. A product of claim 6, one, all, or combination of meridian pathways and acupuncture points of the human body can be heated.

8. Product of claim 6, wherein the power source can be continuously on for one strip or circle and turned off for the rest of the strips and circles.

9. A product of claim 1, wherein the head covering, top (garments that cover the torso), trousers and shorts, foot coverings and foot wear, hand coverings, and undergarments have the capability to be connected to a single power source using connectors located in each piece of apparel. Each piece has the capability to be connected directly to the power source.

10. A product of claim 1, wherein the strip or strips can be layered with the top layer is a colored strip and underneath one or more circles placed at special acupuncture points. The circles at the acupuncture locations underneath are heated.

11. A product of claim 1, wherein the strips and circles are heated using solar power.

12. A product of claim 11, wherein heating one, all, or combination of meridian pathways and acupuncture points of the body can be accomplished by only including those strips or circles on the apparel.

13. A product of claim 11, the strips and circles can be any dark color that attracts the sun.

14. A product of claim 1, wherein the apparel outfit or body suit colors are green, blue, black, red, orange, yellow, white, brown, grey, pink, purple, gold and silver.

15. A product of claim 1, wherein the apparel contains sewed, stitched or printed strips and circles that are arranged at approximate locations along the wearer's body meridian pathways and acupuncture points.
